(19) United States
(12) Patent Application Publication
(10) Pub. No.: US 2011/0307470 A1
(43) Pub. Date: Dec. 15, 2011

(54) DISTRIBUTED DATABASE MANAGEMENT SYSTEM AND DISTRIBUTED DATABASE MANAGEMENT METHOD

(75) Inventors: Junpei Kamimura, Tokyo (JP); Takehiko Kashiwagi, Tokyo (JP)

(73) Assignee: NEC CORPORATION, Tokyo (JP)

(21) Appl. No.: 13/202,914

(22) PCT Filed: Feb. 16, 2010
(86) PCT No.: PCT/JP2010/000935

§ 371 Date: Aug. 23, 2011

(30) Foreign Application Priority Data
Feb. 24, 2009 (JP) 2009-040777

(51) Int. Cl. G06F 17/30; G06F 15/16

(52) U.S. Cl. 707/713; 707/770; 707/E17.017; 707/E17.032

(57) ABSTRACT

Provided is a non-shared type database system capable of efficiently manipulating data in a distributed database. A distributed database management system has a query receiving unit (load balancer) that receives a query; and, plural storage processing units that manipulate data in the distributed database in a cooperative manner on the basis of the received query. Each of the storage processing units includes: a storage device that stores one of partial databases constituting the distributed database; and, a data manipulation unit that manipulates data in the partial databases stored in the storage device on the basis of the received query.

### TECHNICAL FIELD

The present invention relates to a technique for manipulating data in a distributed database.

### BACKGROUND ART

In the field of database processing, cluster structures, which employ multiple processors such as multiple servers, have been widely used in order to distribute loads resulting from a large volume of transaction processes. As a database system with the cluster structure, a shared-disk system and a shared-nothing system have been known. The shared-disk system is a shared-type system in which computer resources such as a CPU and storage are shared, and the shared-nothing system is a non-shared-type system in which the computer resources are not shared. The above-described computer resources not only include the resources of actual computers, but also include resources of virtual computers. The shared-nothing system advantageously provides excellent scalability (expandability of system) as compared with the shared-disk system, since, in the shared-nothing system, the computer resources do not conflict between the processors (servers), whereby it is possible to realize a process efficiency based on the number of processors.

The database system of the shared-nothing type is disclosed, for example, in Patent Document 1 (Japanese Patent Application Laid-open No. 2007-025785) and Patent Document 2 (Japanese Patent Application Laid-open No. 2005-078394).

### RELATED DOCUMENTS

### Patent Documents

Patent Document 1: Japanese Patent Application Laid-open No. 2007-025785
Patent Document 2: Japanese Patent Application Laid-open No. 2005-078394

### SUMMARY OF THE INVENTION

In the database system of the shared-nothing type (non-shared type), the multiple processors each control the non-shared computer resources, and a database is distributed and stored in these non-shaped computer resources. Therefore, the processing speed disadvantageously decreases in the case of performing a query process using the entire data groups that are scatteredly stored in the non-shared computer resources.

For example, the non-shared type database system in Patent Document 2 is configured to include plural database nodes and a load distributing device that manages the plural database nodes. When the load distributing device performs a transaction using plural data groups distributed and stored in the plural database nodes in response to a process request from a client terminal, the load distributing device requests each of the database nodes to transmit data. Then, the load distributing device performs the transaction using the data groups transmitted from each of the database nodes. However, if all the necessary data groups are not transmitted from the database nodes, the load distributing device cannot complete the transaction, which causes the processing speed to reduce.

In view of the circumstances described above, an object of the present invention is to provide a non-shared type database system and a database management method capable of efficiently manipulating data in a distributed database.

According to the present invention, there is provided a distributed database management system for manipulating data in a distributed database. The distributed database management system includes a query receiving unit that receives a query; and, plural storage processing units that manipulate data in the distributed database in a cooperative manner on the basis of the received query, in which each of the plural storage processing units includes: a storage device that stores one of plural partial databases constituting the distributed database; and, a data manipulation unit that manipulates data in the partial databases stored in the storage device on the basis of the received query.

According to the present invention, there is provided a distributed database management method in a distributed database management system having plural storage processing units that manipulate data in a distributed database in a cooperative manner on the basis of a query, each of the storage processing units including a storage device that stores one of plural partial databases constituting the distributed database. The distributed database management method includes: (a) in the case where a data set necessary for manipulating the data on the basis of the query is not stored in the partial database, issuing, by a first storage processing unit of the plural storage processing units, a data transferring request of the data set to a second storage processing unit or plural second storage processing units, each of which is different from the first storage processing unit of the plural storage processing units; (b) in response to the data transferring request, acquiring, by the second storage processing units, the data set from the partial database, and transferring the acquired data set to the first storage processing unit; and, (c) manipulating, by the first storage processing unit, the data using the data set transferred from the second storage, processing unit.

According to the present invention, since plural storage processing units manipulate, in parallel, the data in the partial databases each managed by each of the plural storage processing units in a cooperative manner, whereby it is possible to provide a distributed database management system capable of efficiently manipulating the data in the distributed database.

### BRIEF DESCRIPTION OF THE DRAWINGS

The above-described object and other objects of the present invention, and features and advantages of the present invention will be made further clear by the preferred exemplary embodiment described below and the following attached drawings.

FIG. 1 is a functional block diagram schematically illustrating a configuration of a distributed database management system according to an exemplary embodiment of the present invention;

FIG. 2 is a diagram schematically illustrating an example of a database table constituting the distributed database;

FIG. 3 is a functional block diagram schematically illustrating a configuration of a storage processing unit;

FIG. 4 is a flowchart schematically illustrating a procedure of the transaction process performed by a data manipulation unit of a storage processing unit;

FIG. 5 is a flowchart schematically illustrating a process procedure performed by the data manipulation unit that receives the data transferring request;

FIG. 6 is a diagram schematically illustrating one example of a′communication sequence;

FIG. 7 is a diagram schematically illustrating another example of the communication sequence;

FIG. 8 is a diagram schematically illustrating still another example of the communication sequence;

FIG. 9 is a diagram schematically illustrating still another example of the communication sequence;

FIG. 10 is a diagram schematically illustrating still another example of the communication sequence;

FIG. 11 is a diagram schematically illustrating one example of a structure of a partial database;

FIG. 12 is a diagram schematically illustrating one example of an actual table;

FIG. 13(A) and FIG. 13(B) are diagrams each illustrating a logical data structure constituting a partial database;

FIG. 14 is a diagram schematically illustrating a structure of a partial database;

FIG. 15 are diagrams each schematically illustrating a structure of the partial database; and

FIG. 16 is a diagram for explaining integration and adjustment function of a router.

### DESCRIPTION OF EMBODIMENTS

Hereinbelow, an exemplary embodiment according to the present invention will be described with reference to the drawings. Note that, in all the drawings, the same constituent components are denoted with the same reference numerals, and the detailed explanation thereof will not be repeated.

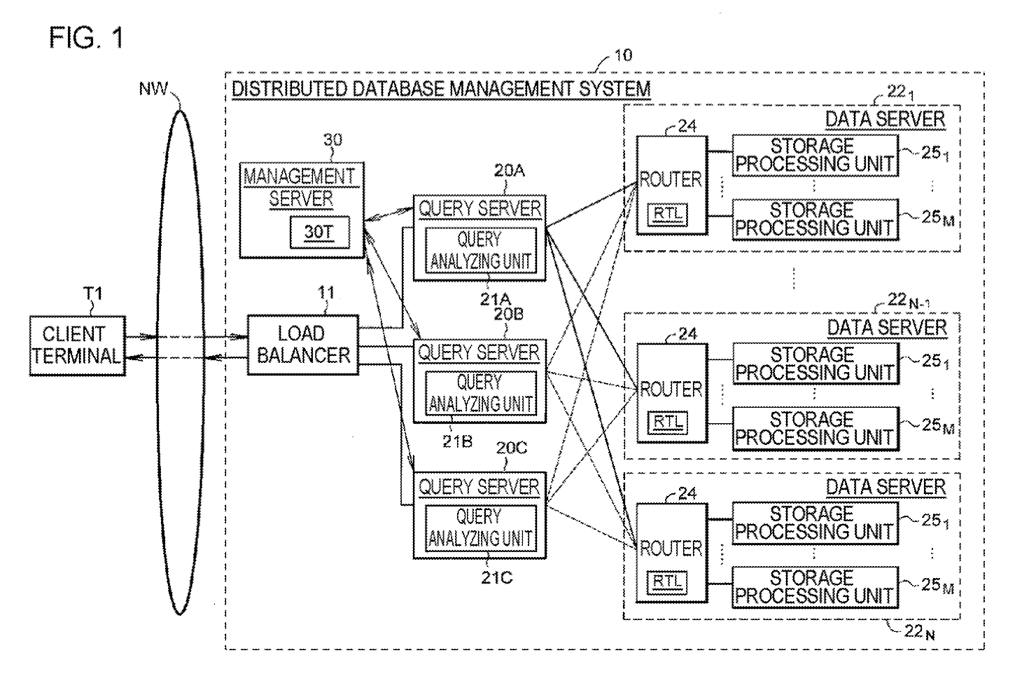

FIG. 1 is a functional block diagram schematically illustrating a configuration of a distributed database management system 10 according to an exemplary embodiment of the present invention. As illustrated in FIG. 1, the distributed database management system 10 includes a load balancer 11, query servers 20A, 20B, 20C, data servers 22₁ to 22_{N}, and a management server 30. The data servers 22₁ to 22_{N} each have a partial database constituting a distributed database. The distributed database management system 10 manipulates data in the distributed database.

As described later, the distributed database has at least one table structure, and the partial database constitutes a subset (partial group) of the table structure.

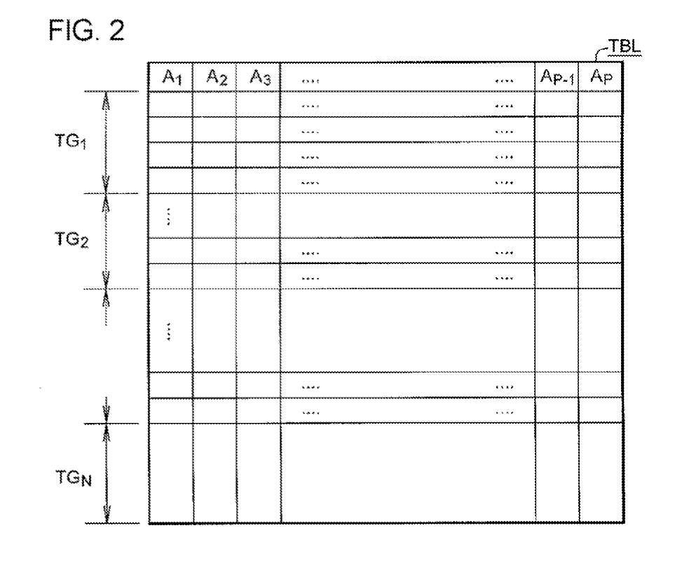

FIG. 2 is a diagram schematically illustrating an example of a database table TBL constituting the distributed database. As illustrated in FIG. 2, the database table TBL has plural tuples (row) and columns (attribute field) A₁, A₂, . . . , A_{P} defined in the column direction. Data are stored in an area determined by an area where a tuple and a column A₁, A₂, . . . , A_{P} intersect. As illustrated in FIG. 2, plural subsets TG₁, TG₂, . . . , TG_{N} can be configured by dividing the database table TBL in the row direction (horizontal dividing). The subsets TG₁, TG₂, . . . , TG_{N} as configured above can be each stored in the data servers 22₁ to 22_{N} as a table of the partial database.

It should be noted that it may be possible to configure plural partial database tables by dividing the database table TBL in the column direction (vertical dividing), or to configure plural partial database tables by combining the horizontal dividing and the vertical dividing.

As illustrated in FIG. 1, the distributed database management system 10 and a client terminal T1 are connected with a communication network NW. In addition to the distributed database management system 10 and the client terminal T1, a large number of client terminals (not shown) are connected with the communication network NW. The network NW includes, for example, a wide-area network such as the Internet, but is not limited to this.

The client terminal T1 has a function of generating a query described in a database language (database manipulation language) such as a structured query language (SQL) and an XML query language XQuery in connection with a database that the distributed database management system 10 has, and transmitting the generated query to the distributed database management system 10. In the query, there is described a database language specifying a data manipulation such as searching, inserting, updating and deleting of data to the distributed database.

The load balancer 11 has a function of receiving a query transmitted from the client terminal T1 through the communication network NW as a request for data processing, and evenly distributing the query (hereinafter, referred to as received query) to the query servers (query receiving units) 20A to 20C to decentralize the processing load. The load balancer 11 may selects any of the query servers 20A to 20C in a round-robin manner.

The query servers 20A, 20B and 20C have query analyzing units 21A, 21B and 21C, respectively. The query analyzing units 21A to 21C each have a function of analyzing the received query distributed by the load balancer 11 and optimizing it. Each of the query analyzing unit 21A to 21C analyzes the received query, and on the basis of the results of the analysis, converts the received query into a query in an analysis tree type optimized so as to be suitable for a specific database structure. At this time, it is possible to convert the received query into a query, for example, in an abstract syntax tree (AST) type.

The data servers 22₁ to 22_{N} each have a router 24 and plural storage processing units 25₁ to 25_{M}. The router 24 has a function of controlling data transfer between given storage processing units among the storage processing units 25₁ to 25_{M}. Further, the data servers 22₁ to 22_{N} are connected with each other through a wired transmission line or wireless transmission line such as a local area network LAN. The router 24 in a given data server 22ᵢ has a function of communicating data with the other router 24 in the other data server 22ⱼ (i≠j).

The management server 30 has plural partial databases constituting the distributed database, and a management table 30T specifying a correspondent relationship with the data servers 22₁ to 22_{N}. Any of the query servers 20A, 20B and 20C transfers the analyzing result of the received query to the management server 30. Then, the management server 30 refers to the management table 30T to determine, based on the analyzing result, a destination to which the query is delivered from among the data servers 22₁ to 22_{N}, and notifies the query server of the analyzing result. In accordance with the notification from the management server 30, the query server transmits the query that has been converted to a single or plural data servers from among the data servers 22₁ to 22_{N}.

The routers 24 have a routing table RTL that stores a correspondent relationship between the storage processing units 25₁ to 25_{M} and database tables stored in the storage processing units 25₁ to 25_{M}. The router 24 refers to the routing table RTL to determine a destination to which the queries received from the query servers 20A to 20C are delivered, from among the storage processing unit 25₁ to 25_{M}.

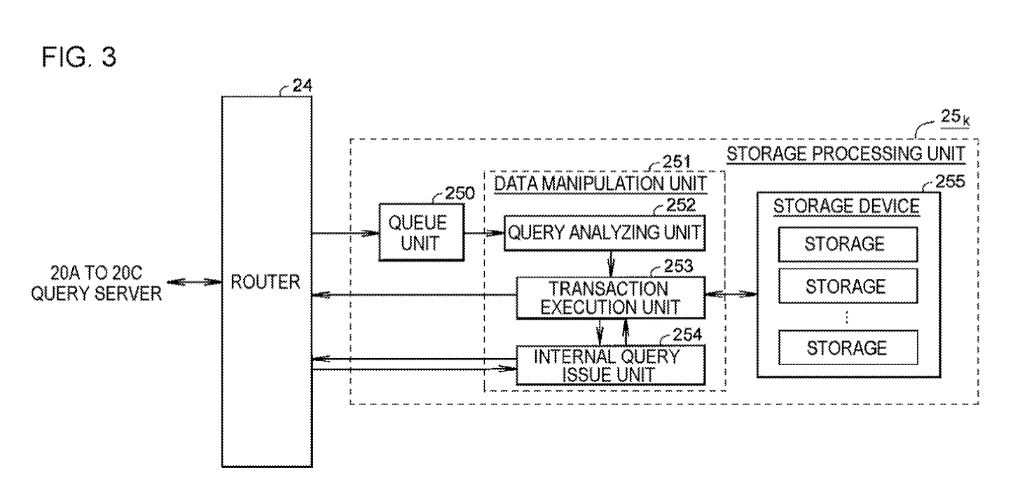

FIG. 3 is a functional block diagram schematically illustrating a configuration of a storage processing unit 25ₖ. As illustrated in FIG. 3, the storage processing unit 25ₖ has a queue unit 250, a data manipulation unit 251, and a storage device 255. The data manipulation unit 251 includes a query analyzing unit 252, a transaction execution unit 253, and an internal query issue unit 254. The storage device 255 has plural storages, a controller for controlling these storages, and an input-and-output port (not shown).

The queue unit 250 has a function of temporarily hold plural queries sequentially received from the router 24, and preferentially supplies a query received and held earlier to the data manipulation unit 251. In the data manipulation unit 251, the query analyzing unit 252 analyzes the query supplied from the queue unit 250, and generates an execution plan. The transaction execution unit 253 executes a transaction according to the execution plan.

In the case where a data set necessary for executing the transaction is not stored in the partial database in the storage device 255, the transaction execution unit 253 issues a data acquiring request concerning the data set to the internal query issue unit 254. The internal query issue unit 254 has a function of, in response to the data acquiring request, generating an internal query, and issuing, to the router 24, a request for transferring data including the internal query, thereby being able to acquire the data set. The function of the query issue unit 254 will be described later. The transaction execution unit 253 executes a transaction using the data set that the internal query issue unit 254 acquires.

The data manipulation unit 251 of the storage processing unit 25ₖ may be realized by hardware such as a semiconductor integrated circuit, or may be realized by an application program or program code recorded in a storage medium such as a nonvolatile memory and optical disk. This program or program code causes a computer having a processor such as a CPU to perform the process of the data manipulation unit 251. This program or program code causes a real calculation machine or virtual calculation machine having a processor such as a CPU to perform a process of all or a part of the functional blocks 252 to 254 in the data manipulation unit 251.

Further, the storage device 255 may be configured by a storage medium such as a volatile memory and nonvolatile memory (for example, semiconductor memory or magnetic recording medium), and a circuit or control program for writing or reading data to or from this storage medium. A storage area in the storage that constitutes the storage device 255 may be configured in advance in a predetermined storage area in the storage medium, or may be configured in an appropriate storage area that is allocated at the time when a system operates.

Operations of the distributed database management system 10 having the configuration described above will be described below.

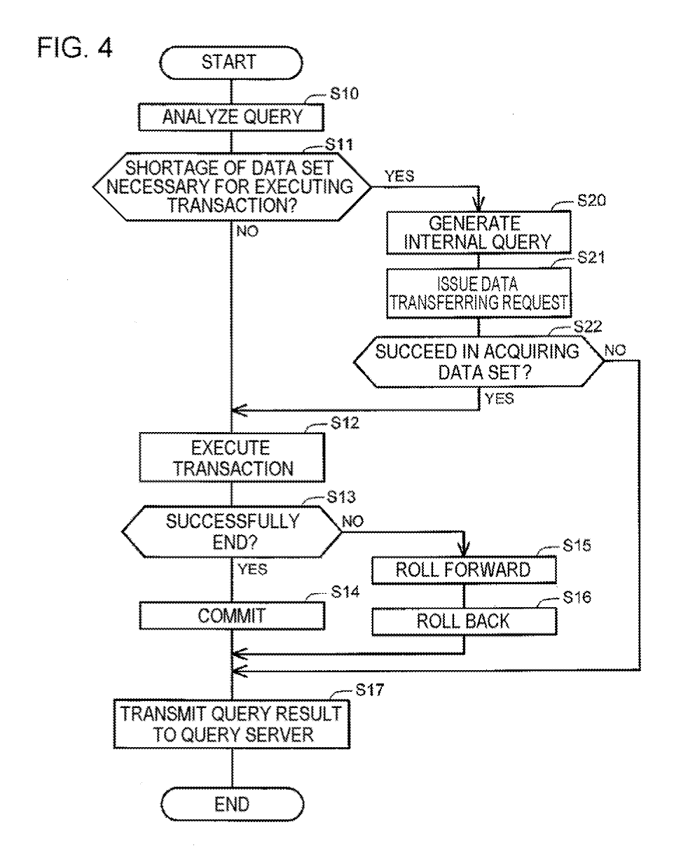

FIG. 4 is a flowchart schematically illustrating a procedure of the transaction process performed by the data manipulation unit 251 of the storage processing unit 25ₖ. As shown in FIG. 4, in the data manipulation unit 251, the query analyzing unit 252 analyzes a query provided from the queue unit 250 (step S10). At this time, the query analyzing unit 252 optimizes the query on the basis of the analyzing result so as to accord with the structure of the partial database stored in the storage device 255, and generates an execution plan.

Then, the transaction execution unit 253 determines whether a data set necessary for executing a transaction is stored in the partial database in the storage device 255 (step S11).

If it is determined that the data set necessary for executing the transaction is stored in the partial database in the storage device 255 (NO in step S11), the transaction execution unit 253 executes the transaction according to the execution plan generated in the query analyzing unit 252, thereby performing a data manipulation such as searching, inserting, updating and deleting of data in the partial database (step S12). The term transaction as used herein means a unit of work including processes such as searching and updating of the database 41, and means a process that satisfies ACID properties including atomicity, consistency, isolation and durability. If the transaction process successfully ends (YES in step S13), the transaction is committed (step S14). Then, the transaction execution unit 253 transmits the execution result of the transaction (query result) to the router 24 (step S17).

On the other hand, if the transaction does not successfully end due to occurrence of trouble concerning the transaction or system (NO in step S13), the transaction execution unit 253 performs a roll-forward (step S15). More specifically, the transaction execution unit 253 checks log information in a period from a certain time point among periodically set check points to a time point when the trouble occurs. If there exists any transaction that is not committed during the period, the transaction execution unit 253 reflects the execution result of this transaction to the partial database on the basis of the log information. Further, the transaction execution unit 253 returns the state of the partial database back to the state before the process of the not-committed transaction starts, in other words, performs the roll back (step S16). Then, the transaction execution unit 253 transmits the execution result of the transaction (query result) to the query server 20A through the router 24 (step S17). The query server 20A transmits the query result to the client terminal T1 through the load balancer 11.

In step S11, if it is determined that the data set necessary for executing the transaction is not stored in the partial database in the storage device 255 (YES in step S11), the transaction execution unit 253 issues a data acquiring request concerning the data set to the internal query issue unit 254. In response to the data acquiring request, the internal query issue unit 254 generates an internal query (step S20), and issues the data transferring request of the data set to the router 24 (step S21). The data transferring request includes the internal query. The internal query may be described in a database language that specifies data manipulation such as searching, inserting, updating and deleting of the data in the database, or may be described in a form that can be performed in the system (for example, an analysis tree type such as an AST form, or a series of process procedure formed by microcode).

For example, in the storage processing unit 25₁, when the internal query issue unit 254 issues the data transferring request (step S21), the router 24 transfers the data transferring request to the other storage processing unit 25₂ to 25_{M} in the data server 22₁, or to the router 24 of the other data server 22₂ to 22_{N}. In the case where the router 24 transfers the data transferring request to the other storage processing unit 25₂ to 25_{M} in the data server 22₁, the data manipulation unit 251 in each of the storage processing unit 25₂ to 25_{M} performs, in response to the data transferring request, a transaction process based on the internal query to the partial database that the data manipulation unit 251 itself manages to manipulate the data (mainly, perform a searching manipulation).

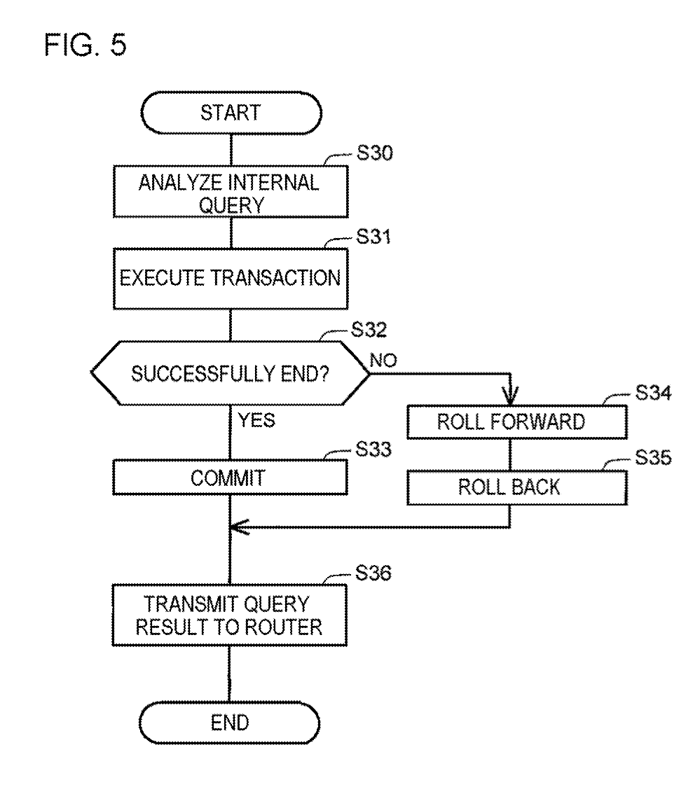

FIG. 5 is a flowchart schematically illustrating a process procedure performed by the data manipulation unit 251 that has received the data transferring request from the storage processing unit 25₁. As illustrated in FIG. 5, the query analyzing unit 252 first analyzes the internal query received from the queue unit 250 (step S30). At this time, the query analyzing unit 252 optimizes the internal query on the basis of the analyzing result so as to accord with the structure of the partial database stored in the storage device 255, and generates an execution plan.

Then, the transaction execution unit 253 executes a transaction according to the execution plan generated by the query analyzing unit 252 to manipulate the data in the partial database (step S31). If the transaction process successfully ends (YES in step S32), the transaction is committed (step S33).

The transaction execution unit 253 transmits the execution result (query result) of the transaction to the storage processing unit 25₁ through the router 24 (step S36). More specifically, if successfully acquiring the data set from the storage device 255, the transaction execution unit 253 transfers the data set to the storage processing unit 25₁ through the router 24. On the other hand, if failing to acquire the data set from the storage device 255, the data manipulation unit 251 notifies the storage processing unit 25₁ through the router 24 that it fails to acquire the data set.

On the other hand, if the transaction does not successfully ends due to occurrence of a trouble in the transaction or system (NO in step S32), the transaction execution unit 253 executes the roll forward (step S34), and further performs the roll back (step S35). Then, the transaction execution unit 253 transmits the execution result (query result) of the transaction to the storage processing unit 25₁ through the router 24 (step S36).

Getting back to the flowchart in FIG. 4, in the storage processing unit 25₁, when the internal query issue unit 254 succeeds in acquiring the data set from any of the storage processing units 25₂ to 25_{M} (YES in step S22), the transaction execution unit 253 executes a transaction using the data set (step S12). Then, the above-described steps S13 through S17 are performed.

On the other hand, in the storage processing unit 25₁, if the internal query issue unit 254 fails to acquire the data set (NO in step S22), the transaction execution unit 253 notifies the query server 20A through the router 24 of the query result including the fact that the data manipulation is not successfully performed. The query server 20A transmits the query result to the client terminal T1 through the load balancer 11.

It should be noted that the query result is transmitted to the client terminal T1 through any one of the query servers 20A, 20B and 20C. At this time, this query server also transmits the query result to the management server 30, and hence, the management server 30 can update the management table 30T on the basis of this query result.

Next, description will be made of communication sequences illustrating operations of the distributed database management system 10.

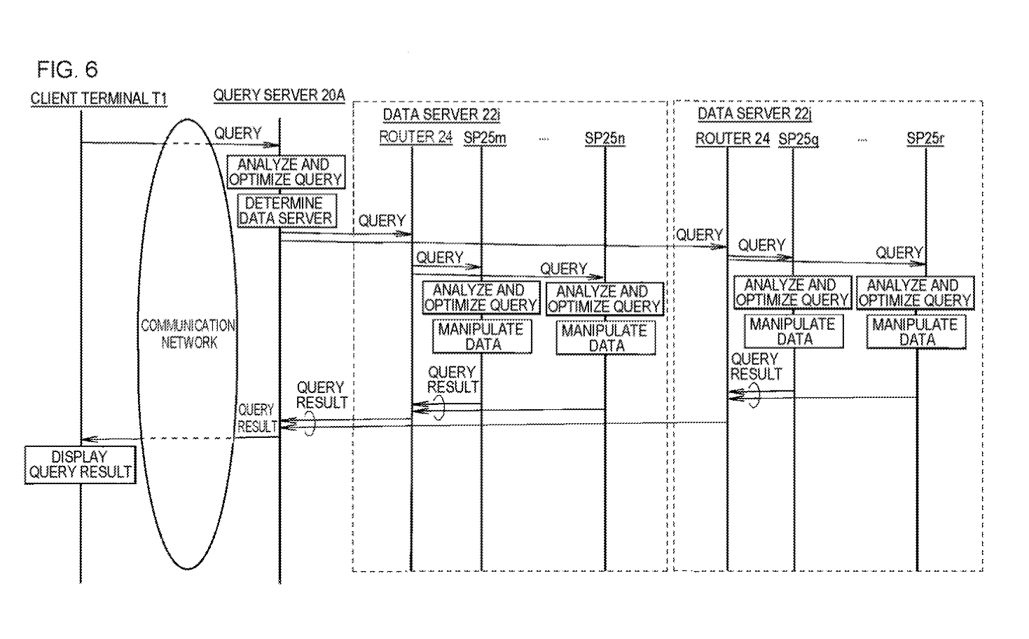

FIG. 6 is a diagram schematically illustrating one example of a communication sequence. As illustrated in FIG. 6, first, when the query server 20A receives a query from the client terminal T1 through the load balancer 11, the query analyzing unit 21A in the query server 20A analyzes the received query, and on the basis of the result of the analysis, converts the received query into a query in an analysis tree type optimized so as to be suitable for a specific database structure. Then, the query analyzing unit 21A determines the data servers 22ᵢ, 22ⱼ to which the query should be transmitted, on the basis of the result of the analysis of the query. After this, the query server 20A transmits the query to the data servers 22ᵢ, 22ⱼ.

In the data server 22ᵢ, the data manipulation unit 251 in each of the SP (storage processing unit) 25ₘ, . . . , 25ₙ analyzes and optimizes the query to generate an execution plan. Similarly, in the data server 22ⱼ, the data manipulation unit 251 in each of the SP (storage processing unit) 25_{q}, . . . , 25ᵣ analyzes and optimizes the query to generate an execution plan. In the case where the query analyzing unit 21A of the query server 20A has already optimized the query so as to accord with the structures of the partial databases managed by the respective data manipulation units 251, the data manipulation unit 251 does not need to optimize the query.

Then, in each of the SP 25ₘ, . . . , 25ₙ, and 25_{q}, . . . , 25ᵣ, the transaction execution unit 253 executes a transaction according to the execution plan to manipulate the data, and transmits the execution result (the query results) to the router 24. The router 24 of the data server 22ᵢ integrates the query results received from the SP 25ₘ, . . . , 25ₙ, and transmits that to the query server 20A. The router 24 of the data server 22ⱼ also integrates the query results received from the SP 25_{q}, . . . , 25ᵣ, and transmits that to the query server 20A. The query server 20A integrates the query results transmitted from the data servers 22ᵢ and 22ⱼ, and transmits the results to the client terminal T1.

As illustrated in FIG. 6, in the distributed database management system 10 according to this exemplary embodiment, plural storage processing units 25ₘ, . . . , 25ₙ, and 25_{q}, . . . , 25ᵣ can parallelly manipulate the data in the partial databases managed by the respective storage processing units 25ₘ, . . . , 25ₙ, and 25_{q}, . . . , 25ᵣ.

For example, when receiving, from the client terminal T1, a query concerning data manipulation such as inserting, deleting and updating of a tuple (record) into, from and to a table in the distributed database, each of the storage processing units 25ₘ, . . . , 25ₙ, and 25_{q}, . . . , 25ᵣ can parallelly and cooperatively perform the data manipulation to the table in the partial database managed by each of the storage processing units 25ₘ, . . . , 25ₙ, and 25_{q}, . . . , 25ᵣ.

When receiving, from the client terminal T1, a query concerning data manipulation of selection to the table in the distributed database (calculation of extracting a tuple that matches a specific condition from tuples constituting the table, and generating a new table from the extracted tuple), each of the storage processing units 25ₘ, . . . , 25ₙ, and 25_{q}, . . . , 25ᵣ can parallelly and cooperatively perform the data manipulation to the table in the partial database managed by each of the storage processing units 25ₘ, . . . , 25ₙ, and 25_{q}, . . . , 25ᵣ. The query server 20A can form a new table in which the execution results (the query results) are integrated, and transmit information on the new table to the client terminal T1. Further, the routers 24, 24 of the data servers 22ᵢ and 22ⱼ each have a function of integrating plural execution results (the query results), and transmitting the results of the integration to the query server 20A. Once the routers 24 of the data servers 22ᵢ and 22ⱼ integrate the execution results and transmit the results of the integration to the query server 20A, the query server 20A can efficiently integrate the results of the query using the results of the integration received from the routers 24, 24.

Further, as illustrated in FIG. 3, one partial database stored in the storage device 255 is allocated to each of the storage processing unit 25ₖ, whereby it is possible to eliminate lock (excluding control) of the partial database as much as possible.

Therefore, the distributed database management system 10 can realize high throughput.

Further, there is an advantage that, since the query servers 20A, 20B and 20C, which are located at a preceding stage of the distributed database management system 10, optimize a query, the storage processing units 25₁ to 25_{M}, which are located at the following stage, do not always need to optimize the query. The storage processing units 25₁ to 25_{M} each have a function of optimizing a query so as to accord with a structure of the partial database managed by each of the storage processing units 25₁ to 25_{M}. If a large part of the storage processing units 25₁ to 25_{M} store a structure of the partial databases having the same structure, the query servers 20A, 20B and 20C located at the preceding stage can collectively perform the optimization so as to be suitable for the structure of the partial databases having the same structure.

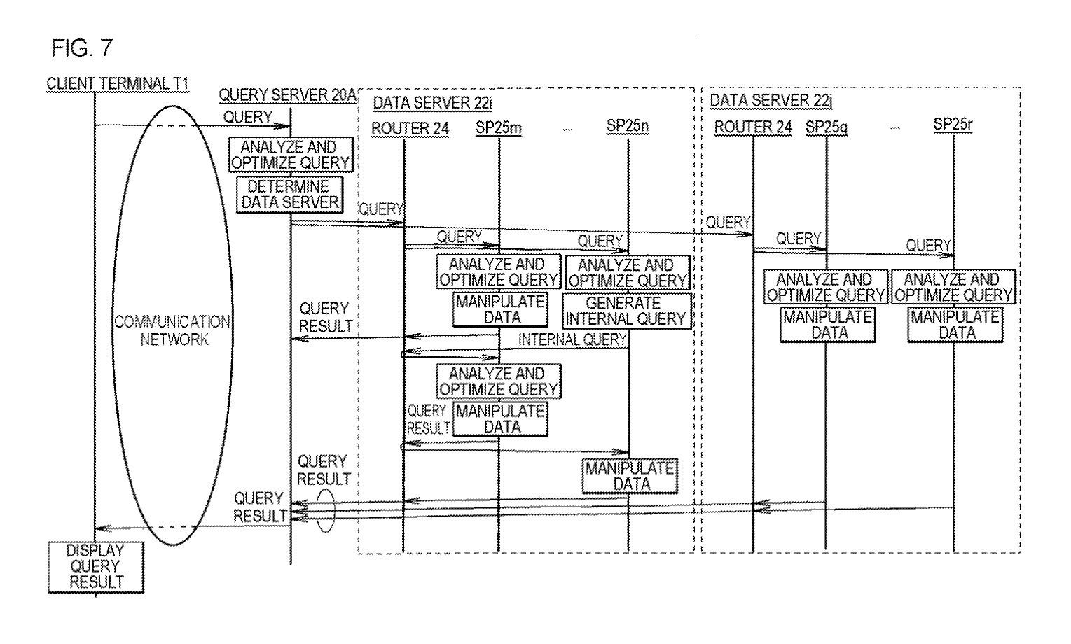

Next, FIG. 7 is a diagram schematically illustrating another example of the communication sequence. First, when the query server 20A receives a query from the client terminal T1 through the load balancer 11, the query analyzing unit 21A of the query server 20A analyzes the received query, and on the basis of the result of the analysis, converts the received query into a query in the analysis tree type optimized so as to be suitable for a specific database structure. Then, the query analyzing unit 21A determines the data servers 22ᵢ, 22ⱼ to which the query should be transmitted, on the basis of the result of the analysis of the query. After this, the query server 20A transmits the query to the routers 24, 24 of the data servers 22ᵢ, 22ⱼ.

In the data server 22ᵢ, the data manipulation unit 251 in each of the SP (storage processing unit) 25ₘ, . . . , 25ₙ analyzes and optimizes the query to generate an execution plan. Similarly, in the data server 22ᵢ, the data manipulation unit 251 in each of the SP (storage processing unit) 25_{q}, . . . , 25ᵣ analyzes and optimizes the query to generate an execution plan. In the case where the query analyzing unit 21A of the query server 20A has already optimized the query so as to accord with the structure of the partial database managed by each of the data manipulation units 251, the data manipulation unit 251 does not need to optimize the query.

Then, in each of the SP 25ₘ, . . . , 25_{q}, . . . , 25ᵣ, the transaction execution unit 253 executes a transaction according to the execution plan to manipulate the data, and transmits the execution result (query result) to the router 24.

In the SP 25ₙ, the transaction execution unit 253 determines that a data set necessary for executing the transaction is not stored in a partial database in the storage device 255 (YES in step S11 in FIG. 4). Then, the transaction execution unit 253 issues, to the internal query issue unit 254, a data acquiring request of the data set.

For example, in the case where the transaction execution unit 253 attempts to perform a selection operation (data manipulation of extracting a tuple that matches a specific condition to generate a new table from the extracted tuple) or a joint operation (data manipulation of jointing plural columns to generate a new table) but the tuple or column necessary for executing the selection operation or the joint operation does not exist in the partial table managed thereby, the transaction execution unit 253 issues, to the internal query issue unit 254, a data acquiring request of the data set concerning the tuple or column.

As illustrated in FIG. 7, the internal query issue unit 254 in the SP 25ₙ issues an internal query in response to the data acquiring request, and transmits a data transferring request including the internal query through the router 24 to the SP 25ₘ. In this case, the SP 25ₘ analyzes and optimizes the transferred internal query to manipulate the data. Then, the SP 25ₘ supplies the data set obtained through the data manipulation, as a query result, to the SP 25ₙ through the router 24.

After this, the transaction execution unit 253 in the SP 25ₙ manipulates the data using the data set acquired by the internal query issue unit 254, and transmits the result of the execution (query result) to the router 24.

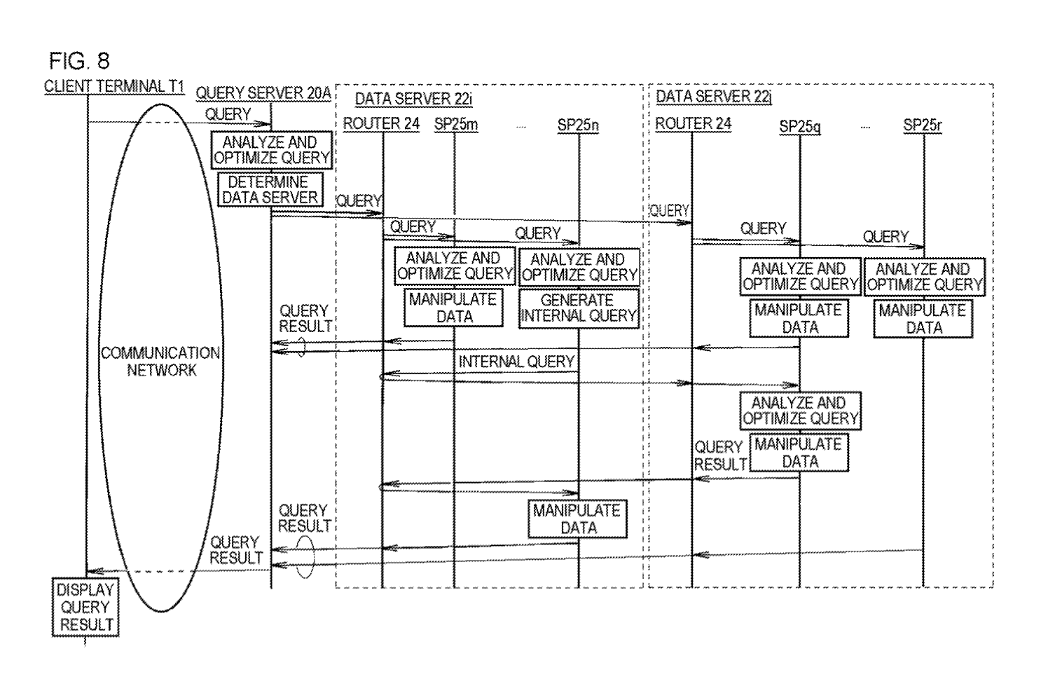

It should be noted that, as illustrated in FIG. 8, the internal query issue unit 254 in the SP 25ₙ may transmit the data transferring request including the internal query to the SP 25_{q} in the data server 22ⱼ through the router 24 in response to the data acquiring request described above. In this case, the SP 25_{q} analyzes and optimizes the transferred internal query to manipulate the data. Then, the SP 25_{q} can supply the query result to the SP 25ₙ through the router 24.

Then, as illustrated in FIG. 7, the router 24 in the data server 22ᵢ integrates the query results received from the SP 25ₘ, . . . , 25ₙ, and transmits them to the query server 20A. Further, the router 24 in the data server 22ⱼ integrates the query results received from the SP 25_{q}, . . . , 25ᵣ, and transmits them to the query server 20A. The query server 20A integrates the query results transmitted by the data server 22ᵢ and 22ⱼ, and transmits the results to the client terminal T1.

As illustrated in FIG. 7 and FIG. 8, in the distributed database management system 10 according to this exemplary embodiment, the storage processing unit 25ₙ in the data server 22ᵢ can acquire a data set insufficient to manipulate the data from other storage processing unit 25ₘ (FIG. 7) or storage processing unit 25_{q} (FIG. 8). The storage processing unit 25ₙ can manipulate the data using the acquired data set, whereby it is possible to efficiently perform the distribution process in the storage processing units 25₁ to 25_{M} as a whole. Therefore, even in the case where a shortage of a data set exists, the distributed database management system 10 can achieve a high throughput.

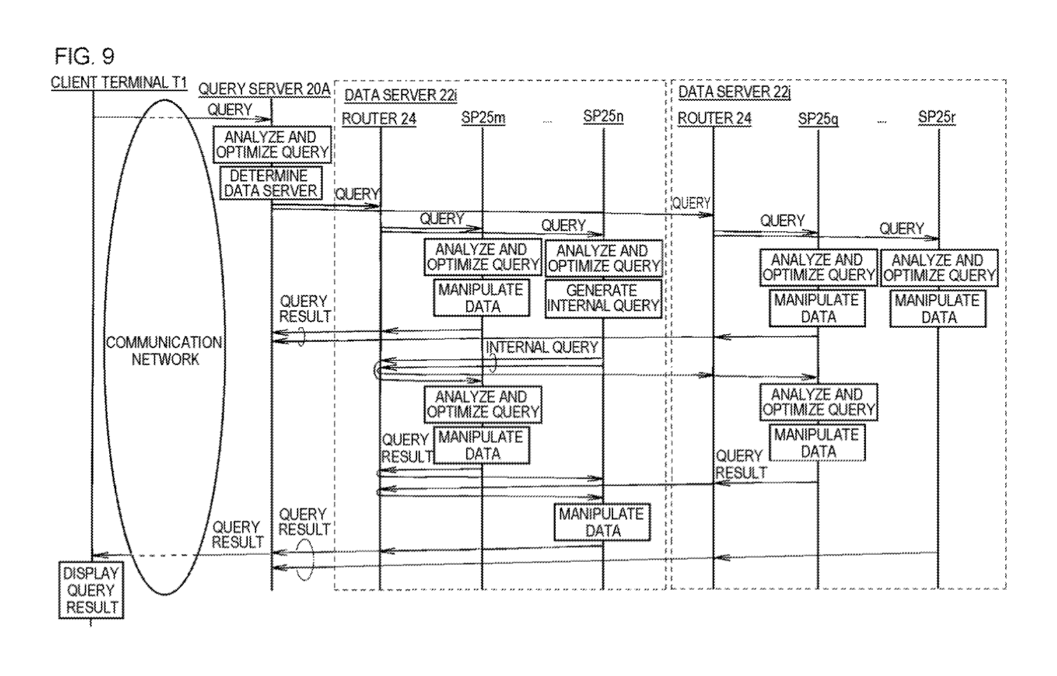

FIG. 9 is a diagram schematically illustrating still another example of the communication sequence. In the communication sequence illustrated in FIG. 9, in the case where there exists the shortage of the data set necessary for the storage processing unit 25ₙ to manipulate the data, the router 24 in the data server 22ᵢ transfers a data transferring request (internal query) to the storage processing unit 25ₘ in the data server 22ᵢ, and at the same time, transfers the data transferring request to the router 24 in other data server 22ⱼ. The router 24 in the data server 22ⱼ transfers the data transferring request (internal query) to the storage processing unit 25_{q} in accordance with the routing table RTL. The data transferring request may be transferred to plural storage processing units 25_{q}, . . . , 25ᵣ. As illustrated in FIG. 9, the storage processing unit 25ₙ acquires data sets, which are the query results, from the storage processing units 25ₘ and 25_{q}, and manipulates the data using the acquired data sets.

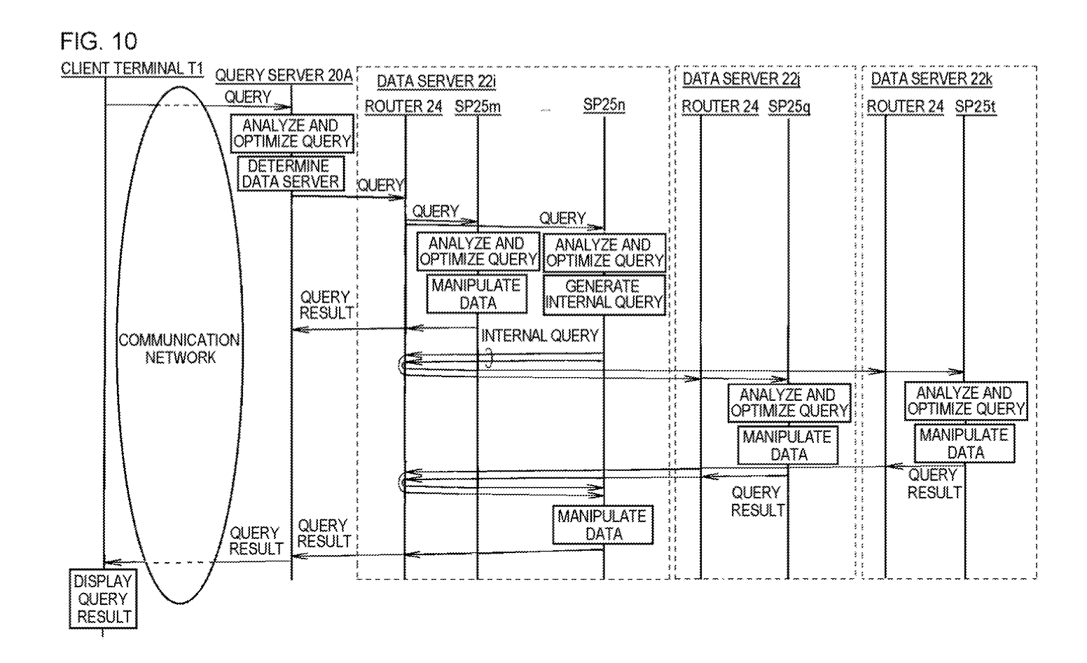

FIG. 10 is a diagram schematically illustrating still another example of the communication sequence. In the communication sequence illustrated in FIG. 10, in the case where there exists the shortage of the data set insufficient for the storage processing unit 25ₙ to manipulate the data, the router 24 in the data server 22ᵢ transfers a data transferring request (internal query) to the router 24 in the external data server 22ⱼ, and at the same time, transfers the data transferring request to the router 24 in the external data server 22ₖ. The router 24 in the data server 22ⱼ transfers the data transferring request (internal query) to the storage processing unit 25_{q} in accordance with the routing table RTL. In parallel to this, the router 24 in the data server 22ₖ transfers the data transferring request (internal query) to the storage processing unit 25ₜ in accordance with the routing table RTL.

Then, as illustrated in FIG. 10, the storage processing units 25_{q} and 25ₜ each transmit the data set, which is the query result, to the storage processing unit 25ₙ in the data server 22ᵢ through the routers 24, 24. The storage processing unit 25ₙ acquires the data sets, which are the query results, from the storage processing units 25_{q} and 25ₜ, and manipulates the data using the acquired data sets.

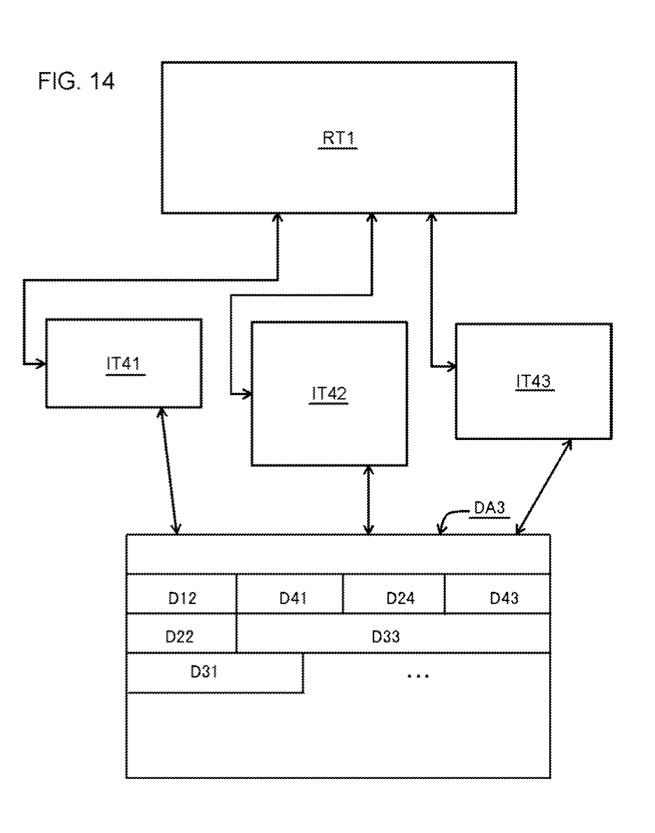

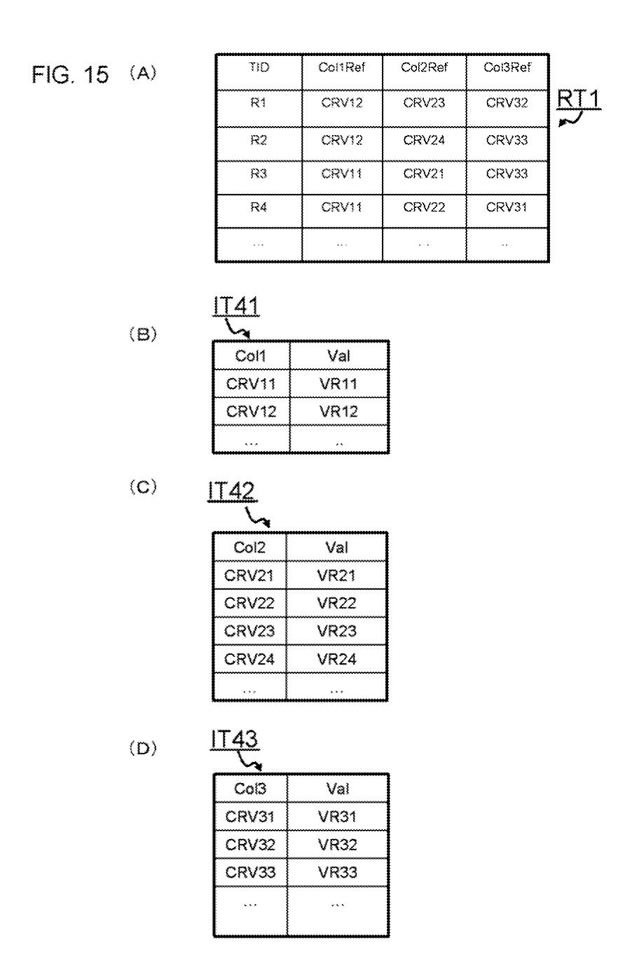

Incidentally, FIG. 7 illustrates a mode in which, in the data server 22ᵢ, only one storage processing unit 25ₘ transmits the insufficient data set to the storage processing unit 25ₙ. However, the present invention is not limited to this mode. It may be possible to employ a mode in which, in the data server 22ᵢ, plural storage processing units 25ₘ, . . . , 25ᵤ transmit the insufficient data sets to the storage processing unit 25ₙ. In this case, the router 24 in the data server 22ᵢ has a function of integrating the insufficient data sets transmitted from the plural storage processing units 25ₘ, . . . , 25ᵤ to configure a new table, and transmitting a data set of the new table through the router 24 to the storage processing unit 25ₙ. As described later, the partial database can be configured by a group of entity data, a reference table, and plural intermediate identifier tables stored in the storage area of the storage device 255 (see FIG. 14 to FIG. 15). When configuring a new table by integrating the data sets of this type of partial database, the entity data having the same value are not transferred redundantly, whereby it is possible to reduce the amount of data transferred in the same data server 22ᵢ.

FIG. 8 illustrates a mode in which, in the data server 22ⱼ, only one storage processing unit 25_{q} transmits the insufficient data set to the storage processing unit 25ₙ through the router 24 in the data server 22ᵢ. However, the present invention is not limited to this mode. It may be possible to employ a mode in which, in the data server 22ⱼ, plural storage processing units 25_{q}, . . . , 25ᵣ transmit the insufficient data sets to the storage processing unit 25ₙ through the routers 24, 24 in the data servers 22ⱼ and 22ᵢ. In this case, the router 24 in the data server 22ⱼ has a function of integrating the insufficient data sets transmitted from the plural storage processing units 25_{q}, . . . , 25ᵣ to configure a new table, and transmitting a data set of the new table through the router 24 to the storage processing unit 25ₙ. With the partial database illustrated in FIG. 14, the router 24 in the data server 22ⱼ integrates the data sets of the partial database, whereby it is possible to reduce the amount of data transmitted between the data servers 22ⱼ and 22ᵢ.

In the case of FIG. 9, the storage processing unit 25ₘ in the data server 22ᵢ transmits the insufficient data set through the router 24 to the storage processing unit 25ₙ in the data server 22ᵢ, and the storage processing unit 25ᵤ in the data server 22ⱼ also transmits the insufficient data set through the router 24 to the storage processing unit 25ₙ in the data server 22ᵢ. The router 24 in the data server 22ᵢ has a function of integrating the data sets to configure a new table, and transmitting a data set of the new table to the storage processing unit 25ₙ. With the partial database illustrated in FIG. 14, the router 24 in the data server 22ᵢ integrates the data sets of the partial database, whereby it is possible to reduce the amount of data transferred to the storage processing unit 25ₙ from the router 24 in the data server 22ᵢ. In the case of FIG. 10, the storage processing unit 25ₙ in the data server 22ᵢ receives the insufficient data sets from the storage processing units 25_{q} and 25ₜ in two data servers 22ⱼ and 22ₖ through the router 24. In this case, with the partial database illustrated in FIG. 14, the router 24 in the data server 22ᵢ integrates the data sets of the partial database, whereby it is possible to reduce the amount of data transferred from the router 24 in the data server 22ᵢ to the storage processing unit 25ₙ.

Further, when there is plural insufficient data sets, the storage processing unit 25ₙ may manipulate the data after acquiring all the insufficient data sets, or may manipulate the data using a part of the insufficient data sets at a point in time when acquiring the part of the insufficient data sets. In the communication sequence illustrated in FIG. 9, the storage processing unit 25ₙ manipulates the data after acquiring all the data sets, which are the query results, from the storage processing unit 25ₘ and the storage processing unit 25_{q}. In place of this, the storage processing unit 25ₙ may manipulate the data using only a first data set immediately after acquiring the first data set from the storage processing unit 25ₘ, and then, may manipulate the data using a second data set after acquiring the second data set from the storage processing unit 25_{q}.

Next, a preferred example of a structure of a partial database constituting the distributed database will be described.

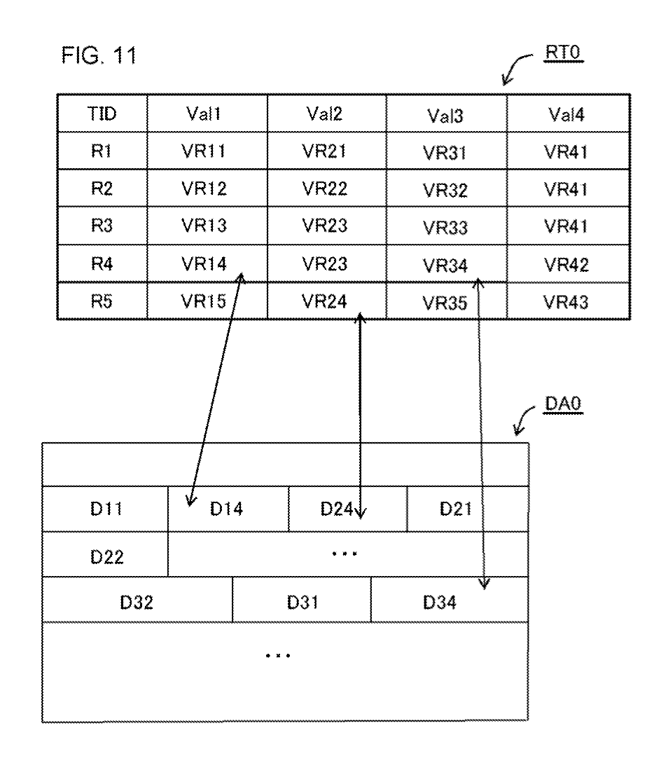

FIG. 11 is a diagram schematically illustrating one example of a structure of a partial database. As illustrated in FIG. 11, the partial database structure has a group of entity data stored in a storage area DA0 in the storage device 255, and a reference table (identifier table) RT0 stored in a storage area different from the storage area DA0 in the storage device 255.

The reference table RT0 has five tuples defined in a row direction, and five attribute fields TID, Val1, Val2, Val3, Val4 defined in a column direction. In a first exemplary embodiment, although the number of tuples of the reference table RT0 is set to five for the purpose of facilitating explanation, the number is not limited to this, and the number of tuples may be set, for example, in the range of tens to millions. Further, the number of attribute fields TID, Val1, Val2, Val3, Val4 is not limited to five.

Tuple identifiers (TID) R1, R2, R3, R4 and R5 are allocated uniquely to the respective five tuples of the reference table RT0. Each data identifiers VR11, VR12, . . . , VR43 with fixed lengths is stored in an area defined by the tuples and the attribute fields Val1, Val2, Val3, Val4 (area at which a tuple intersects an attribute field Val1, Val2, Val3, Val4). More specifically, the attribute field Val1 includes the data identifiers VR11, VR12, VR13, VR14 and VR15, which are located in the areas corresponding to the tuple identifiers R1, R2, R3, R4 and R5, respectively; the attribute field Val2 includes the data identifiers VR21, VR22, VR23, VR23 and VR24, which are located in the areas corresponding to the tuple identifiers R1, R2, R3, R4 and R5, respectively; the attribute field Val3 includes the data identifiers VR31, VR32, VR33, VR34 and VR35, which are located in the areas corresponding to the tuple identifiers R1, R2, R3, R4 and R5, respectively; and, the attribute field Val4 includes the data identifiers VR41, VR41, VR41, VR42 and VR43, which are located in the areas corresponding to the tuple identifiers R1, R2, R3, R4 and R5, respectively.

The values of the data identifiers VR11 to VR43 can be obtained by using a hash function. The hash function is a logical operator for outputting a bit stream having a fixed length in response to input of a bit stream of entity data. The output values (hash values) of the hash function can be used as the values of the data identifiers VR11 to VR34. The transaction execution unit 253 converts a search string into a hash value, and retrieves, from the reference table RT0, a data identifier having a value that matches the resulting hash value, thereby being able to obtain entity data corresponding to the retrieved data identifier from the storage area DA0. At this time, the transaction execution unit 253 searches the reference table RT0, which does not include the variable lengths and is formed only by the group of data having fixed lengths, whereby it is possible to rapidly retrieve the strings.

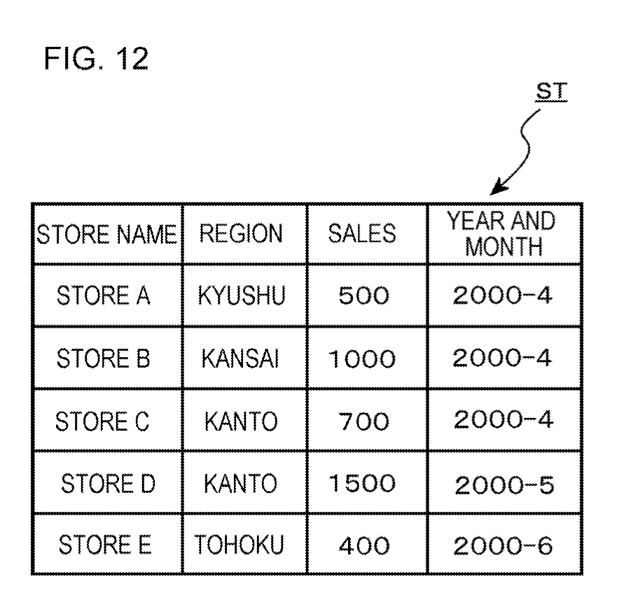

It is possible to set the names of attribute fields Val1, Val2, Val3 (attribute name), for example, to be “store name,” “region,” “sales” and “year and month.” The database structure illustrated in FIG. 11 may be generated from an actual table, which is a group of entity data. FIG. 12 is a diagram schematically illustrating one example of an actual table ST. The entity data of “store A,” “store B” and “Kyushu” in the actual table ST with five rows and four columns are subjected to the hash process (converting the values of the entity data into hash values), whereby it is possible to generate the data identifiers VR11, VR12, . . . , VR34 with the fixed length illustrated in FIG. 11.

The data identifiers VR11 to VR43 described above have values each substantially uniquely representing the respective entity data stored in the storage area DA0. Therefore, the transaction execution unit 253 searches the data identifiers VR11 to VR43, and can access, on the basis of the results of the searching, the entity data having variable lengths, each of which corresponds to each of the data identifiers VR11 to VR43. Note that the term “substantially uniquely” as used in this specification means that uniqueness is satisfied in terms of manipulating the data in the partial database.

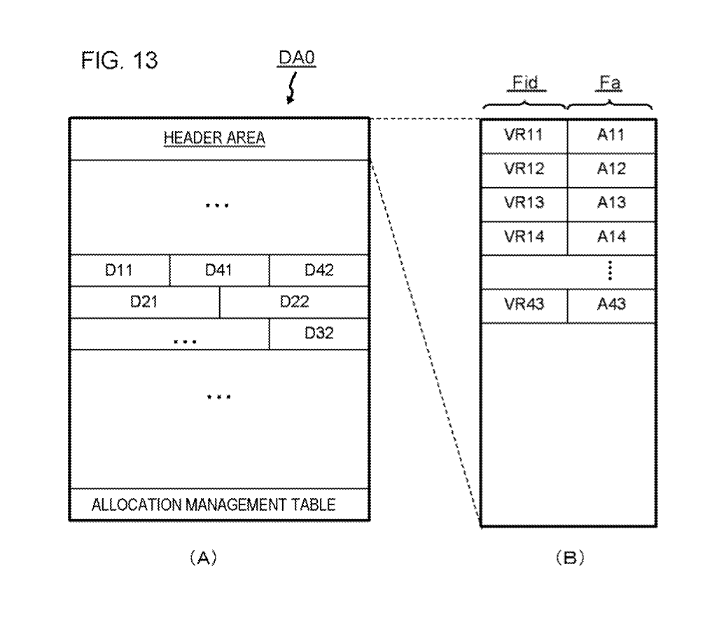

FIG. 13(A) and FIG. 13(B) are diagrams each illustrating a logical data structure constituting the partial database. The data structure illustrated in FIG. 13(A) has a header area at the head portion thereof, and has an allocation management table at the end portion thereof. Further, an area for containing the group of entity data is disposed between the header area and the allocation management table.

FIG. 13(B) is a schematic view illustrating an example of a conversion table contained in the header area. The conversion table is a table for specifying the correspondent relationship between the data identifiers VR11 to VR43 and the storage areas of the data identifiers VR11 to VR43. As illustrated in FIG. 13(B), the conversion table has areas Fid for containing the data identifiers VR11 to VR34, and areas Fa for containing position data A11 to A43 each indicating a storage area for each of the data identifiers VR11 to VR34.

As illustrated in FIG. 11, the storage area DA0 for the entity data D11 to D43, and the storage areas for the data identifiers VR11 to VR43 each uniquely representing the entity data D11 to D43 are completely isolated from each other, whereby it is possible to enhance the efficiency of the updating process of the partial database, improve the searching speed, and improve the transportation property.

For example, when a part of the group of the entity data in the storage area DA0 is updated, added or deleted, it is only necessary to update the reference table RT0 and the conversion table illustrated in FIG. 13(B), whereby the updating process can be performed in a short period of time. Since it is possible to minimize the update of the partial database at the time of updating, adding or deleting of the entity data, it is possible to efficiently and rapidly perform the updating even in the case where the updating is frequently performed to the partial database.

Further, the conversion table in FIG. 13(B) is formed such that overlap of the data identifiers with the same value is excluded (more specifically, any two data identifiers have different values from each other in the conversion table without fail). Therefore, with the conversion table, it is possible to store entity data having the same value in the storage area DA0 without overlapping the entity data with each other. In other words, a group of entity data constituting the partial database can be compressed to store it in the storage area DA0, whereby it is possible to efficiently use the storage area DA0.

Next, another preferred example of a structure of the partial database will be described.

FIG. 14 is a diagram schematically illustrating a structure of the partial database. As illustrated in FIG. 14, this database structure has a group of entity data stored in a storage area DA3 in the storage device 255, and further has a reference table RT1 and a first to third intermediate identifier tables IT41, IT42 and IT43 stored in storage areas, which are different from the storage area DA3.

FIG. 15(A) is a diagram illustrating a schematic configuration of the reference table RT1. The reference table RT1 has plural tuples defined in the row direction, and four attribute fields TID, Col1Ref, Col2Ref and Col3Ref defined in the column direction. The number of the tuples in the reference table RT1 may be set, for example, in the range of tens to millions. Further, the number of attribute fields TID, Col1Ref, Col2Ref and Col3Ref is not limited to four.

Tuple identifiers (TID) R1, R2, R3, R4, . . . are allocated uniquely to tuples in the reference table RT1. Reference identifiers CRV11, CRV12, . . . , CRV31, . . . with fixed lengths are each stored in an area defined by the tuple and the attribute fields Col1Ref, Col2Ref, Col3Ref (area at which the tuple intersects the attribute field Col1Ref, Col2Ref, Col3Ref). Values of the reference identifiers CRV11 to CRV31 can be obtained by using the hash function as is the case with the data identifiers in the first exemplary embodiment. More specifically, the values of the reference identifiers CRV11 to CRV31 can be set to the output values of the hash function, which are output in response to input of the data identifiers VR11 to VR31.

FIG. 15(B) to FIG. 15(D) are diagrams schematically illustrating structures of the first to third intermediate identifier tables IT41, IT42 and IT43. The first intermediate identifier table IT41 has plural tuples defined in the row direction, and two attribute fields Col1 and Val defined in the column direction. The attribute field Col1 contains the reference identifiers CRV11, CRV12, . . . with fixed lengths. The attribute field Val contains the data identifiers VR11, VR12, . . . with fixed lengths, each of the data identifiers being in an area corresponding to each of the tuples.

The second intermediate identifier table IT42 has plural tuples defined in the row direction, and two attribute fields Col2 and Val defined in the column direction. The attribute field Col2 contains the reference identifiers CRV21, CRV22, . . . with fixed lengths. The attribute field Val contains the data identifiers VR21, VR22, . . . with fixed lengths, each of the data identifiers being in an area corresponding to each of the tuples.

The third intermediate identifier table IT43 has plural tuples defined in the row direction, and two attribute fields Col3 and Val defined in the column direction. The attribute field Col3 contains the reference identifiers CRV31, CRV32, . . . with fixed lengths. The attribute field Val contains the data identifiers VR31, VR32, . . . with fixed lengths, each of the data identifiers being in an area corresponding to each of the tuples.

Each of the first to third intermediate identifier tables IT41, IT42 and IT43 does not include any reference identifiers whose values overlap with each other (more specifically, values of any two reference identifiers in each of the intermediate identifier tables are different without fail), and hence, has a data structure in which redundancy is eliminated. In other words, the intermediate identifier tables IT41, IT42 and IT43 are tables for specifying a one-to-one correspondent relationship between the reference identifiers and the data identifiers in a manner that excludes the overlap of the correspondent relationship. As illustrated in FIG. 15(A), the reference identifiers CRV12, CRV12, CRV11, CRV11, . . . are contained in the column of the attribute field Col1Ref in the reference table RT1. As illustrated in FIG. 15(B), the intermediate identifier table IT41 corresponding to the attribute field Col1Ref is a table for specifying the correspondent relationship between the reference identifiers CRV12, CRV12, CRV11, CRV11, . . . and the data identifiers VR12, VR12, VR11, VR11, . . . . In the intermediate identifier table IT41, the correspondent relationships overlapping with each other are excluded (for example, the correspondent relationships between the reference identifier CRV12 and the data identifier VR12 are not specified in a manner that overlaps with each other). Similarly, as illustrated in FIG. 15(C) and FIG. 15(D), the correspondent relationships overlapping with each other are excluded in the intermediate identifier table IT42 corresponding to the attribute field Col2Ref and the intermediate identifier table IT43 corresponding to the attribute field Col3Ref.

The transaction execution unit 253 searches the reference identifiers CRV11 to CRV33 and the data identifiers VR11 to VR33, and can access the entity data with variable lengths using the results of the searching. Since the storage area DA3 has the conversion tables similar to the conversion tables illustrated in FIG. 13(A), the transaction execution unit 253 can access the entity data on the basis of the results of the searching.

As described above, each of the first to third intermediate identifier tables IT41, IT42 and IT43 has a data structure in which redundancy is eliminated. Therefore, in the case where there exists shortage of a data set necessary for the storage processing unit 25ₙ in the data server 22ᵢ to manipulate data and the storage processing unit 25ₙ acquires the insufficient data set from the storage processing unit 25ₘ (FIG. 7) or the storage processing unit 25_{q} (FIG. 8) having the partial database with the structure illustrated in FIG. 14, the data set having the same value is not necessary to be frequently transferred, by using the intermediate identifier tables IT41, IT42 and IT43, whereby it is possible to obtain an advantage in which the amount of data set to be transferred can be reduced.

For example, in the case where the storage processing unit 25ₘ receives a data transferring request of a data set by one column in the attribute field Col1Ref in the reference table RT1 illustrated in FIG. 15(A), it is only necessary for the storage processing unit 25ₘ to transmit the reference identifiers CRV12, CRV12, CRV11, CRV11, . . . with fixed lengths as well as to transmit the reference identifiers CRV11, CRV12, . . . and the entity data D11, D12, . . . corresponding thereto using the correspondent relationship of the intermediate identifier table IT41. In this case, the values of the reference identifiers CRV12, CRV12, CRV11, CRV11, . . . are values (hash values) outputted from a compression function called a hash function, and the entity data having the same value do not overlap with each other at the time of transferring the entity data, whereby it is possible to reduce the amount of data to be transferred.

The intermediate identifier tables IT41, IT42 and IT43 are each formed on a column basis. This provides an advantage of reducing the amount of data to be transferred, even in the case where the storage processing unit 25ᵢ performs the joint operation (data manipulation of jointing plural columns to generate a new table), and the insufficient data set necessary for the joint operation is transferred from the other storage processing unit 25ⱼ to the storage processing unit 25ᵢ.

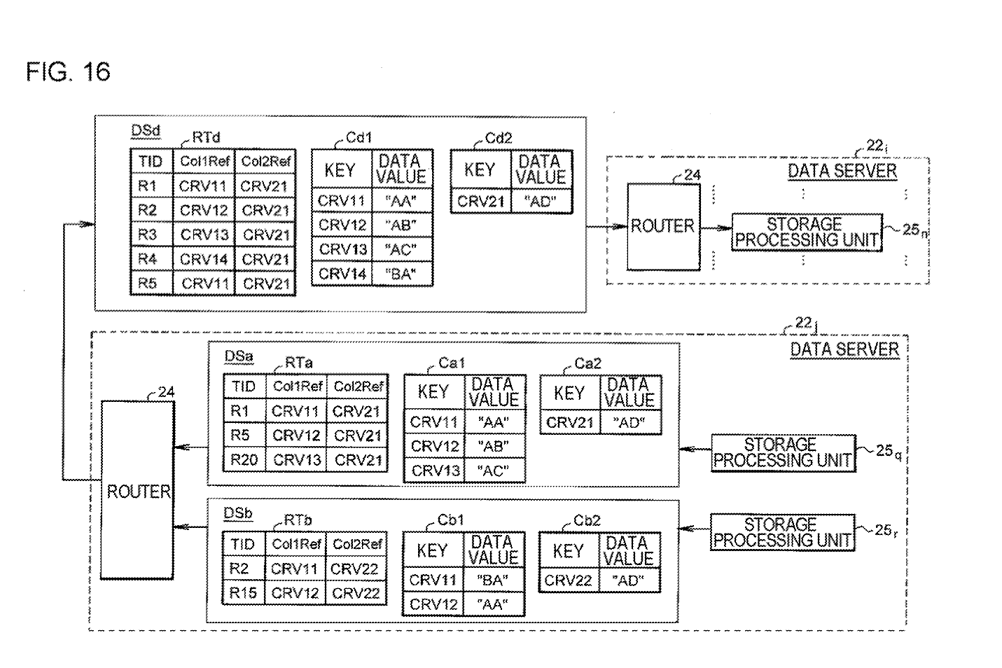

All the storage processing units 25₁ to 25_{M} may use the same hash function for calculating the reference identifiers and the data identifiers, or it may be possible to use hash functions different from each other. However, in the case where each of the storage processing units uses a hash function different from each other, there is a possibility that, for entity data having the same value, hash values of the data identifiers or the reference identifiers are different between the storage processing units 25_{q} and 25ᵣ for example. As described above, the router 24 has a function of integrating the data sets transferred from the plural storage processing units 25_{q} and 25ᵣ and configuring a new table. At the time of the integration, the router 24 adjusts inconsistency of the data identifiers or the reference identifiers. FIG. 16 is a diagram for explaining the integration and the adjustment function of the router 24.

As illustrated in FIG. 16, the storage processing units 25_{q} and 25ᵣ in the data server 22ⱼ transmit data sets DSa and DSb, respectively, to the router 24 in response to a data transferring request from the storage processing unit 25ₙ in the data server 22ᵢ. As illustrated in FIG. 16, the data set DSa is data formed by tables RTa, Ca1 and Ca2, whereas the data set DSb is data formed by table RTb, Cb1 and Cb2. The router 24 in the data server 22ⱼ integrates the data sets DSa and DSb, configures new tables RTd, Cd1 and Cd2, and transfers a data set DSd of the new tables RTd, Cd1, Cd2 to the data server 22ᵢ.

The reference table RTa has the structure same as the reference table RT1 illustrated in FIG. 15(A). The tables Ca1 and Ca2 are formed by using the intermediate identifier table in the storage processing unit 25_{q}. The table Ca1 is a table for specifying a one-to-one correspondent relationship between the reference identifiers CRV11, CRV12 and CRV13, and the entity data values “AA,” “AB” and “AC,” and the table Ca2 is a table for specifying a one-to-one correspondent relationship between the reference identifier CRV21 and the entity data value “AD.” Similarly, the reference table RTb has the structure same as the reference table RT1 illustrated in FIG. 15(A). The tables Cb1 and Cb2 are formed by using the intermediate identifier table in the storage processing unit 25ᵣ. The table Cb1 is a table for specifying a one-to-one correspondent relationship between the reference identifiers CRV11 and CRV12 and the entity data values “BA” and “AA,” and the table Cb2 is a table for specifying a one-to-one relationship between the reference identifier CRV22 and the entity data value “AD.”

As illustrated in FIG. 16, in the table Ca1 and the table Cb1, different reference identifiers CRV11 and CRV12 are used for the same entity data value “AA.” Further, in the table Ca2 and the table Cb2, different reference identifiers CRV21 and CRV22 are used for the same entity data value “AD.” In the cases above, at the time of forming the reference tables RTd and the tables Cd1 and Cd2 by integrating the data sets DSa and DSb, the router 24 uniquely allocates the reference identifier CRV11 to the same entity data value “AA,” and uniquely allocates the reference identifier CRV21 to the same entity data value “AD.” With this configuration, it is possible to resolve the inconsistency of the reference identifiers.

More specifically, the following procedure can be employ for example. First, the router 24 checks the inconsistency of the reference identifiers with respect to the same entity data value between the data sets DSa and DSb. If it is found as a result of the check that inconsistency exists in the reference identifiers, the router 24 updates the reference identifiers in the table RTb, Cb1 and Cb2 by using the hash function used in the storage processing unit 25_{q} of the storage processing units 25_{q} and 25ᵣ. At this time, the router 24 may generate a conversion table concerning hush values, and update the reference identifiers in the table RTb, Cb1 and Cb2 in accordance with the generated conversion table. Then, the router 24 integrates the updated tables RTb, Cb1 and Cb2, and the tables RTa, Ca1 and Ca2 to form new tables RTd, Cd1 and Cd2. After this, the tables RTb, Cb1 and Cb2 and the tables RTa, Ca1 and Ca2 are discarded.

The exemplary embodiment according to the present invention has been described with reference to the drawings. However, these are merely examples of the present invention, and it may be possible to employ various configurations other than those described above. For example, the exemplary embodiment described above has a preferred configuration for performing the transaction to the distributed database, but the present invention is not limited to this. As described above, the transaction is a process that satisfies the ACID properties, and it is possible to apply the present invention to a data manipulation in which any of the properties in the ACID properties is not satisfied.

In the exemplary embodiment above, as illustrated in FIG. 1, the distributed database management system 10 has three query servers 20A, 20B and 20C, but is not limited to this. Further, each of the data servers 22₁ to 22_{N} has plural storage processing units 25₁ to 25_{M}, but is not limited to this. Any of the data server 22ᵢ may have a single storage processing unit. The data servers 22₁ to 22_{N} have the same basic functions, but it is not necessary that hardware configurations in the data servers 22₁ to 22_{N} are the same.

Further, as described above, the router 24 has the function of integrating plural query results (data sets). However, it may be possible that the router 24 does not perform the integration in order to reduce the processing time.

The present application claims priority based on Japanese Patent Application No. 2009-040777 filed with Japan Patent Office (filing date: Feb. 24, 2009), all of which disclosure is incorporated herein by reference as a part of the present specification.

1. A distributed database management system for manipulating data in a distributed database, comprising:
a query receiving unit that receives a query; and,
a plurality of storage processing units that manipulates data in the distributed database in a cooperative manner on the basis of the received query, wherein
each of the plurality of the storage processing units includes:
a storage device that stores one of a plurality of partial databases constituting the distributed database; and,
a data manipulation unit that manipulates data in the partial databases stored in the storage device on the basis of the received query.

2. The distributed database management system according to claim 1, wherein,
in the case where a data set necessary for manipulating the data on the basis of the query is not stored in the partial database of a first storage processing unit of the plurality of the storage processing units, the data manipulation unit in the first storage processing unit issues a data transferring request of the data set to a second storage processing unit or a plurality of second storage processing unit, each of which is different from the first storage processing unit of the plurality of the storage processing units, and,
in response to the data transferring request, the data manipulation unit of the second storage processing unit acquires the data set from the partial database of the second storage processing unit, and transfers the acquired data set to the first storage processing unit.

3. The distributed database management system according to claim 2, further comprising a router that performs routing between the plurality of the storage processing units and the query receiving unit, and controls data transmission between given storage processing units of the plurality of the storage processing units, wherein
the router integrates the data sets transferred from the plurality of the second storage processing units to form a new table, and transfers a data set of the new table to the first storage processing unit.

4. The distributed database management system according to claim 2, wherein
the data manipulation unit in the first storage processing unit generates an internal query as the data transferring request, and
the data manipulation unit in the second storage processing unit manipulates data in the partial database of the second storage processing unit on the basis of the internal query to acquire the data set.

5. The distributed database management system according to claim 1, wherein
the query is described in a database language specifying one or more data manipulations selected from among searching, inserting, updating and deleting of data in the database.

6. The distributed database management system according to claim 5, wherein
the data manipulation unit includes:
a query analyzing unit that analyzes an internal query; and,
a transaction execution unit that executes a transaction based on the result of the analysis by the query analyzing unit to manipulate the data.

7. The distributed database management system according to claim 6, wherein
the query analyzing unit optimizes the internal query so as to be suitable for a data structure of the partial database stored in the storage device.

8. The distributed database management system according to claim 1, wherein
the query receiving unit includes the query analyzing unit that analyzes and optimizes the received query.

9. The distributed database management system according to claim 1, wherein
the partial database includes:
a plurality of entity data;
an identifier table contains data identifiers with fixed lengths each uniquely representing each of the entity data, in an area specified by at least one tuple defined in a row direction and at least one attributed field defined in a column direction; and,
a conversion table representing a correspondent relationship between position data each indicating a storage area of each of the entity data and each of the data identifiers.

10. The distributed database management system according to claim 9, wherein
a storage area for the identifier table and a storage area for the entity data are allocated differently from each other.

11. The distributed database management system according to claim 9, wherein
a value of each of the data identifiers is a value outputted from a hash function for outputting a bit stream with a fixed length in response to input of the entity data.

12. The distributed database management system according to claim 9, wherein
a plurality of identifier tables is provided;
the partial database further includes a reference table including a group of reference identifiers each uniquely representing each of the data identifiers in the plurality of the identifier tables; and,
the data manipulation unit manipulates the data using the reference table and the identifier tables.

13. The distributed database management system according to claim 12, wherein
each of the identifier tables specifies a one-to-one correspondent relationship between the reference identifiers and the data identifiers so as to exclude overlap of the one-to-one correspondent relationship.

14. A distributed database management method in a distributed database management system including a plurality of storage processing units that manipulates data in a distributed database in a cooperative manner on the basis of a query, each of the storage processing units including a storage device that stores one of a plurality of partial databases constituting the distributed database, the distributed database management method including:
in the case where a data set necessary for manipulating the data on the basis of the query is not stored in the partial database, issuing, by a first storage processing unit of the plurality of the storage processing units, a data transferring request of the data set to a second storage processing unit or a plurality of second storage processing units, each of which is different from the first storage processing unit of the plurality of the storage processing units;
in response to the data transferring request, acquiring, by the second storage processing units, the data set from the partial database, and transferring the acquired data set to the first storage processing unit; and,
manipulating, by the first storage processing unit, the data using the data set transferred from the second storage processing unit.

15. The distributed database management method according to claim 14, wherein
said issuing the data transferring request includes generating an internal query as the data transferring request, and
said acquiring the data set includes manipulating data in the partial database on the basis of the internal query, thereby acquiring the data set.

16. The distributed database management method according to claim 15, further including:
optimizing the internal query so as to be suitable for a data structure of the partial database stored in the storage device.

17. The distributed database management method according to claim 14, further including:
receiving the query; and,
analyzing and optimizing the received query.

18. The distributed database management method according to claim 14, wherein
the partial database includes:
a plurality of entity data;
an identifier table that contains data identifiers with fixed lengths each uniquely representing the entity data in an area specified by at least one tuple defined in a row direction and at least one attributed field defined in a column direction; and,
a conversion table that represents a correspondent relationship between position data each indicating a storage area of each of the plurality of the entity data and the data identifiers.

19. The distributed database management method according to claim 18, wherein
a plurality of identifier tables is provided;
the partial database further includes a reference table having a group of reference identifiers each uniquely representing each of the data identifiers in the plurality of the identifier tables; and,
data are manipulated using the reference table and the identifier tables.

20. The distributed database management method according to claim 19, wherein
each of the identifier tables specifies a one-to-one correspondent relationship between the reference identifiers and the data identifiers so as to exclude overlap of the one-to-one correspondent relationship.
